(19) United States
(12) Patent Application Publication
(10) Pub. No.: US 2025/0336085 A1
(43) Pub. Date: Oct. 30, 2025

(54) SYSTEMS AND METHODS FOR THREE-DIMENSIONAL (3D) POSE ESTIMATION

(71) Applicant: Samsung Electronics Co., Ltd., Suwon-si (KR)

(72) Inventors: Dongfang Zhao, San Diego, CA (US); Yangwen Liang, San Diego, CA (US); Shuangquan Wang, San Diego, CA (US); Kee-Bong Song, San Diego, CA (US)

(21) Appl. No.: 19/012,561

(22) Filed: Jan. 7, 2025

Related U.S. Application Data
(60) Provisional application No. 63/639,391, filed on Apr. 26, 2024.

(51) Int. Cl. G06T 7/73; G06V 10/80

(52) U.S. Cl. CPC G06T 7/73; G06V 10/806; G06T 2207/30196

(57) ABSTRACT

A method and system are disclosed for estimating a 3-dimensional (3D) pose. The method includes receiving by a computing device a first input generated based on first features associated with first image data from a first sensor associated with the computing device and based on second image data from a second sensor associated with the computing device, and a second input generated based on second features associated with the first image data and based on the second image data, based on the first input and the second input, generating, by the computing device, 3D pose-estimation data associated with an object represented in the first image data and represented in the second image data, and transmitting the 3D pose-estimation data.

### CROSS-REFERENCE TO RELATED APPLICATION

This application claims the priority benefit under 35 U.S.C. § 119(e) of U.S. Provisional Application No. 63/639,391, filed on Apr. 26, 2024, the disclosure of which is incorporated by reference in its entirety as if fully set forth herein.

### TECHNICAL FIELD

The disclosure generally relates to machine learning. More particularly, the subject matter disclosed herein relates to improvements to pose estimation for objects capable of interacting with a device.

### SUMMARY

Devices (e.g., virtual reality (VR) devices, augmented reality (AR) devices, communications devices, medical devices, appliances, machines, etc.) may be configured to make determinations about interactions with the devices. For example, a VR or AR device may be configured to detect interactions (e.g., human-device interactions), such as specific hand gestures (or hand poses). The device may use information associated with the interactions to perform an operation on the device (e.g., changing a setting on the device). Similarly, any suitable device may be configured to estimate different interactions with the device and perform operations associated with the estimated interactions.

Three-dimensional (3D) pose estimation (e.g., 3D hand-pose estimation) from single or stereo images has become increasingly popular. Some applications of hand-pose estimation include human-computer interaction (e.g., human-device interaction), where accurate prediction of human-device interaction is suitable. Some devices may not be able to perform pose estimations as accurately as desired. Some devices may not be able to perform accurate pose estimations in a mobile-friendly manner. Aspects of some embodiments of the present disclosure provide for high-accuracy mobile-friendly 3D pose estimation (e.g., 3D hand-pose estimation (HPE)) from stereo images (e.g., from stereo gray images).

In some embodiments, a feature extraction backbone network may be combined with a convolutional-neural-network-(CNN-) based feature fusion module (FFM) (e.g., a feature fusion circuit) and a cross-feature-attention (CFA) module (e.g., a cross-feature-attention circuit) for 3D pose estimation (e.g., for 3D hand joint position prediction). As used herein, a “cross-feature-attention circuit” or “CFA circuit” refers to one or more components that are configured to perform a cross-attention operation on input features. As used herein, “attentions” refer to important features relevant to 3D pose estimation. For example, performing an attention operation refers to determining a relative importance of an input feature. As used herein, “performing a cross-attention operation on input features” refers to determining a relative importance of input features from left input-image data and right input-image data to generate an output of the cross-attention operation. For example, the output of a CFA circuit may include the input features with their corresponding attentions relevant to 3D pose estimation. To improve the ability of the 3D pose-estimation model to extract 3D hand-joint positions, the FFM may be used to fuse the features from the stereo images, and the CFA may be used to capture the attentions (or similar features) from the stereo images. Aspects of some embodiments of the present disclosure may provide for improved-accuracy 3D pose estimation for diverse pose conditions (e.g., under diverse hand-pose conditions).

Aspects of some embodiments of the present disclosure provide for high 3D estimation accuracy, low complexity, and hardware-friendly design with only neural network (e.g., convolutional neural network (CNN)) layers being used to process the stereo images.

According to some embodiments of the present disclosure, a method for estimating a 3D pose includes receiving by a computing device a first input generated based on first features associated with first image data from a first sensor associated with the computing device and based on second image data from a second sensor associated with the computing device, and a second input generated based on second features associated with the first image data and based on the second image data, based on the first input and the second input, generating, by the computing device, 3D pose-estimation data associated with an object represented in the first image data and represented in the second image data, and transmitting the 3D pose-estimation data.

The method may further include receiving, by the computing device, a third input including first sensor parameters associated with the first sensor.

The 3D pose-estimation data may be generated based on output data including output features with corresponding attentions, the output data being generated based on performing a concatenation operation on the first input and the second input, and performing a second operation on the first input and an operand that is based on a result of the concatenation operation, the second operation being an add operation or a multiplication operation.

The first features may include first fused-feature data associated with the first image data and the second image data, and the second features may include second fused-feature data associated with the first image data and the second image data.

The method may further include receiving, by the computing device, first image features from the first image data as a first feature-fusion input, receiving, by the computing device, second image features from the second image data as a second feature-fusion input, and generating the first fused-feature data based on the first feature-fusion input and the second feature-fusion input.

The method may further include performing, by the computing device, a first concatenation operation and a first convolution operation on the first image features and on the second image features.

The first sensor may be positioned at a first location on an enclosure associated with the computing device, the second sensor may be positioned at a second location on the enclosure associated with the computing device, and the second location may be a different location from the first location.

The first image data may include first gray image data generated by the first sensor, and the second image data may include second gray image data generated by the second sensor.

The object may include a hand, and the 3D pose-estimation data may include 3D hand-joint data.

According to other embodiments of the present disclosure, a system for estimating a 3D pose includes one or more processors, and a memory storing instructions which, when executed by the one or more processors, cause performance of receiving by the one or more processors a first input generated based on first features associated with first image data from a first sensor and based on second image data from a second sensor, and a second input generated based on second features associated with the first image data and based on the second image data, generating, based on an output of the one or more processors, 3D pose-estimation data associated with an object represented in the first image data and represented in the second image data, and transmitting the 3D pose-estimation data.

The instructions, when executed by the one or more processors, may cause performance of receiving, by the one or more processors, a third input including first sensor parameters associated with the first sensor.

The output of the one or more processors may include output features with corresponding attentions generated based on performing a concatenation operation on the first input and the second input, and performing a second operation on the first input and an operand that is based on a result of the concatenation operation, the second operation being an add operation or a multiplication operation.

The first features may include first fused-feature data associated with the first image data and the second image data, and the second features may include second fused-feature data associated with the first image data and the second image data.

The instructions, when executed by the one or more processors, may cause performance of receiving, by the one or more processors, first image features from the first image data as a first feature-fusion input, receiving, by the one or more processors, second image features from the second image data as a second feature-fusion input, and generating the first fused-feature data based on the first feature-fusion input and the second feature-fusion input.

The instructions, when executed by the one or more processors, may cause performance of a first concatenation operation and a first convolution operation on the first image features and on the second image features.

The first sensor may be positioned at a first location on the system, the second sensor may be positioned at a second location on the system, and the second location may be a different location from the first location.

The first image data may include first gray image data generated by the first sensor, and the second image data may include second gray image data generated by the second sensor.

The object may include a hand, and the 3D pose-estimation data may include 3D hand-joint data.

According to other embodiments of the present disclosure, a system for estimating a 3D pose includes means for processing, and a memory storing instructions which, when executed by the means for processing, cause performance of receiving, by the means for processing a first input generated based on first features associated with first image data from a first sensor and based on second image data from a second sensor, and a second input generated based on second features associated with the first image data and based on the second image data, generating, based on an output of the means for processing, 3D pose-estimation data associated with an object in the first image data and in the second image data, and transmitting the 3D pose-estimation data.

The instructions, when executed by the means for processing may cause performance of receiving, by the means for processing, a third input including first sensor parameters associated with the first sensor.

### BRIEF DESCRIPTION OF THE DRAWING

In the following section, the aspects of the subject matter disclosed herein will be described with reference to exemplary embodiments illustrated in the figures.

FIG. 1 is a block diagram depicting a system for estimating a 3D pose, according to some embodiments of the present disclosure.

FIG. 2 is a block diagram depicting operations of a fusion-feature circuit, according to some embodiments of the present disclosure.

FIG. 3A is a block diagram depicting operations of a left CFA circuit, according to some embodiments of the present disclosure.

FIG. 3B is a block diagram depicting operations of a right CFA circuit, according to some embodiments of the present disclosure.

FIG. 4 is a block diagram of an electronic device in a network environment, according to some embodiments of the present disclosure.

FIG. 5 is a flowchart depicting example operations of a method for 3D pose estimation, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “computing device” refers to a hardware configuration for performing functions associated with the devices, components, and/or modules disclosed herein. The hardware configuration may perform the functions with or without executing software and/or firmware instructions.

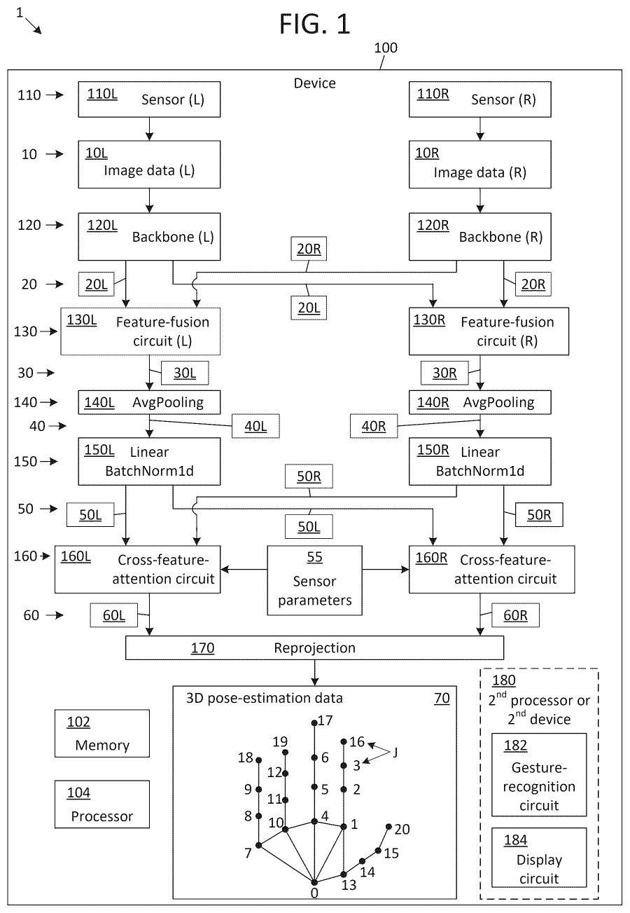

FIG. 1 is a block diagram depicting a system for estimating a 3D pose, according to some embodiments of the present disclosure.

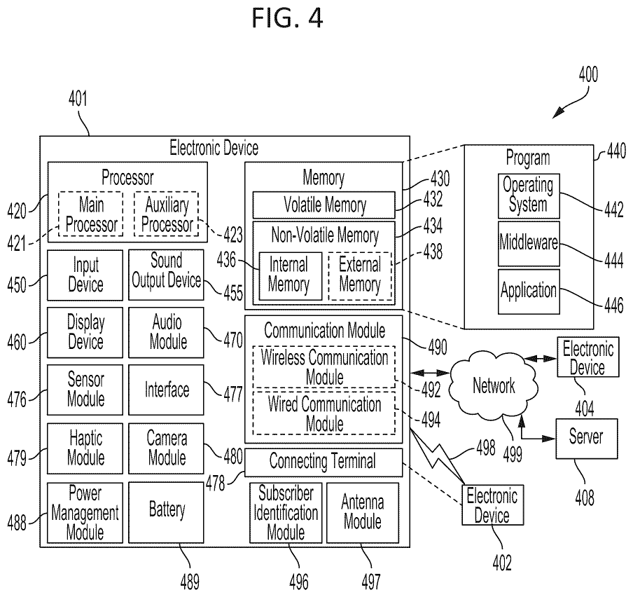

Referring to FIG. 1, a system 1 for 3D pose estimation may include a device 100 (e.g., a first device) including a memory 102 and a processor 104 communicatively coupled to each other. The memory 102 may correspond to a memory 430 of FIG. 4. The processor 104 may correspond to a processor 420 of FIG. 4. In some embodiments, the processor 104 and the memory 102 may be used to perform operations associated with one or more components for 3D pose estimation. The device 100 (e.g., one or more enclosures of the device) may include sensors 110. The sensors may include a left sensor 110L and a right sensor 110R. For example, the sensors 110 may include stereo cameras for generating stereo images (e.g., for generating stereo gray images). In some embodiments, the left sensor 110L may include a camera that generates left image data 10L based on being located at a first location (e.g., a left position) on the device 100. The right sensor 110R may include a camera that generates right image data 10R based on being located at a second location (e.g., a right position) on the device 100. For example, the left image data 10L may correspond to a left camera image and the right image data 10R may correspond to a right camera image, the left and right camera images together may provide for (e.g., may allow for generating) a stereo image.

In some embodiments, gray images may be used to help in making the 3D pose estimation provided by the system 1 more mobile friendly. For example, gray images (which may be associated with one channel) may have lower information density than red-green-blue (RGB) images (which may be associated with three channels).

The left image data 10L and the right image data 10R may be processed by components of the device 100 to generate 3D pose-estimation data 70 (e.g., to generate 3D hand joints). The 3D hand joints may include a number of joints J for determining gestures corresponding to the relative locations of the joints J. For example, a human hand may be represented by data indicating relative locations (e.g., relative positions) of 21 joints J (e.g., a joint 0 through a joint 20). In some embodiments, the 3D pose-estimation data 70 may be transmitted by the device 100 (e.g., by components of the device 100) for further processing by a second processor and/or a second device 180 or for further processing by a separate process (or a separate thread, or function, or subroutine) running on the device 100. For example, the 3D pose-estimation data 70 may be transmitted to, and further processed by, a gesture-recognition circuit 182 and/or a display circuit 184. The display circuit 184 may be associated with a display device 460 of FIG. 4. For example, the gesture-recognition circuit 182 may classify a gesture indicated by the 3D pose-estimation data 70. The display circuit 184 may display the 3D pose-estimation data overlaying (e.g., covering the surface of) an object that is capable of interacting with the device 100. For example, the display circuit 184 may display 3D hand joints overlaid on a human hand. In some embodiments, the 3D pose-estimation data 70 may be used to determine a gesture for changing a setting on the device 100.

They system 1 may include backbones 120 for extracting features from the image data 10. For example, the backbones 120 may include a left backbone 120L for extracting features from the left image data 10L and a right backbone 120R, for extracting features from the right image data 10R. In some embodiments, the backbones 120 may be pretrained for image classification and may generate features associated with the image data 10. The components downstream from the backbones 120 (e.g., further along the signal chain from the sensors 110 and the backbones 120) may process backbone-extracted feature data 20 to generate the 3D pose-estimation data 70, instead of outputting image classifications. The backbone-extracted feature data 20 may include left backbone-extracted feature data 20L (e.g., left feature-fusion-circuit input data, also referred to as a feature-fusion input) generated by the left backbone 120L and may include right backbone-extracted feature data 20R (e.g., right feature-fusion-circuit input data, also referred to as a feature-fusion input) generated by the right backbone 120R. The backbone-extracted feature data 20 may include higher-level features than features generated by the components downstream from the backbones 120. For example, the higher-level features may include features that are related to two-dimensional (2D) hand joints. For example, because each backbone 120 receives a 2D image as an input, the features extracted by one backbone 120 may be related to 2D hand joints, instead of 3D hand joints. In some embodiments, the backbones 120 may include neural networks that are pre-trained on large data sets for efficient feature extraction.

In some embodiments, the left backbone-extracted feature data 20L and the right backbone-extracted feature data 20R may be received as inputs to feature- fusion circuits 130. For example, a left feature-fusion circuit 130L may receive the left backbone-extracted feature data 20L and the right backbone-extracted feature data 20R as feature-fusion-circuit inputs, and a right feature-fusion circuit 130R may receive the left backbone-extracted feature data 20L and the right backbone-extracted feature data 20R as feature-fusion-circuit inputs.

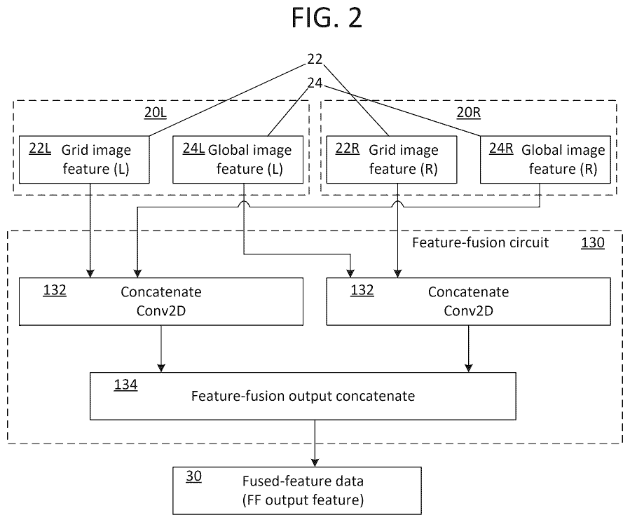

The feature-fusion circuits 130 may each generate fused-feature data 30 based on the feature-fusion-circuit inputs by fusing (e.g., processing together) the left backbone-extracted feature data 20L and the right backbone-extracted feature data 20R for more accurate and richer information, due to features associated with both the left image data 10L and the right image data 10R being fused together in the fused-feature data 30 for further processing. For example, the left feature-fusion circuit 130L may generate left fused-feature data 30L, and the right feature-fusion circuit 130R may generate right fused-feature data 30R. Operations of the feature-fusion circuits 130 are discussed in further detail below with respect to FIG. 2.

In some embodiments, the components of the left side and the components of the right side may use the same parameters. However, as discussed in further detail below, the ordering of the parameters for some right-side components and for some left-side components may be different from their counterparts on the left side or the right side.

In some embodiments, average pooling operations 140 and linear-batch-normalization operations 150 may be performed on the fused-feature data 30. Average pooling may make the features smaller and more dense. For example, the left fused-feature data 30L may include a 10×8×8 matrix, while left average-pooling feature data 40L may include a 10×1 matrix that is more dense (e.g., more dense with features) than the 10×8×8 matrix after left average pooling operations 140L are applied to the left fused-feature data 30L. Likewise, the right fused-feature data 30R may include a 10×8×8 matrix, while right average-pooling feature data 40R may include a 10×1 matrix that is more dense (e.g., more dense with features) than the 10×8×8 matrix after right average pooling operations 140R are applied to the right fused-feature data 30R.

In some embodiments, linear-batch-normalization operations 150 may be performed on average-pooling feature data 40 (e.g., on the left average-pooling feature data 40L and the right average-pooling feature data 40R) to generate linear-batch-normalization feature data 50. The linear-batch-normalization feature data 50 may include more parameters (e.g., more learnable parameters) than the average-pooling feature data 40 for processing the features. The linear-batch-normalization feature data 50 may include more accurate features than the average-pooling feature data 40. The linear-batch-normalization operations 150 may provide the linear-batch-normalization feature data 50 in a standard distribution for inputting to cross-feature attention (CFA) circuits 160 as CFA left-data inputs (e.g., corresponding to left linear-batch-normalization feature data 50L) and as CFA right-data inputs (e.g., corresponding to right linear-batch-normalization feature data 50R).

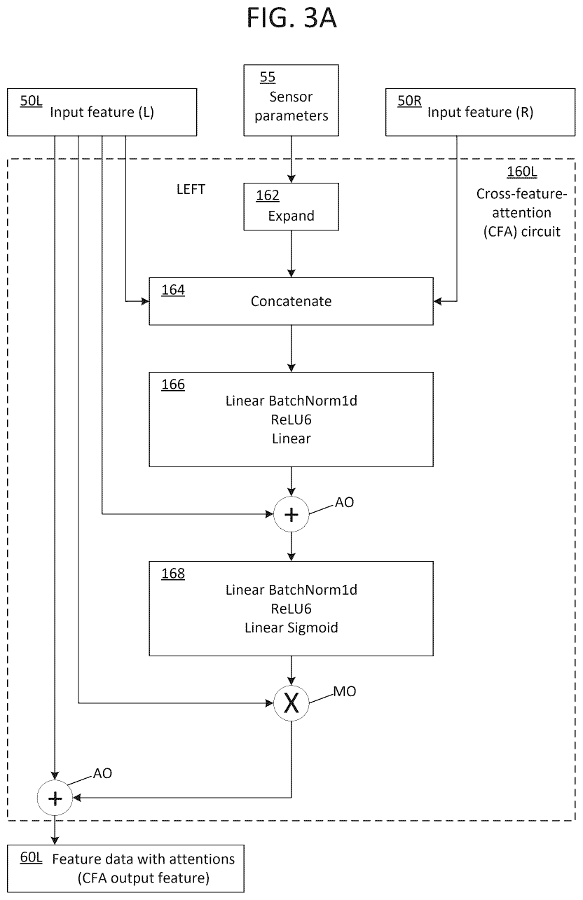

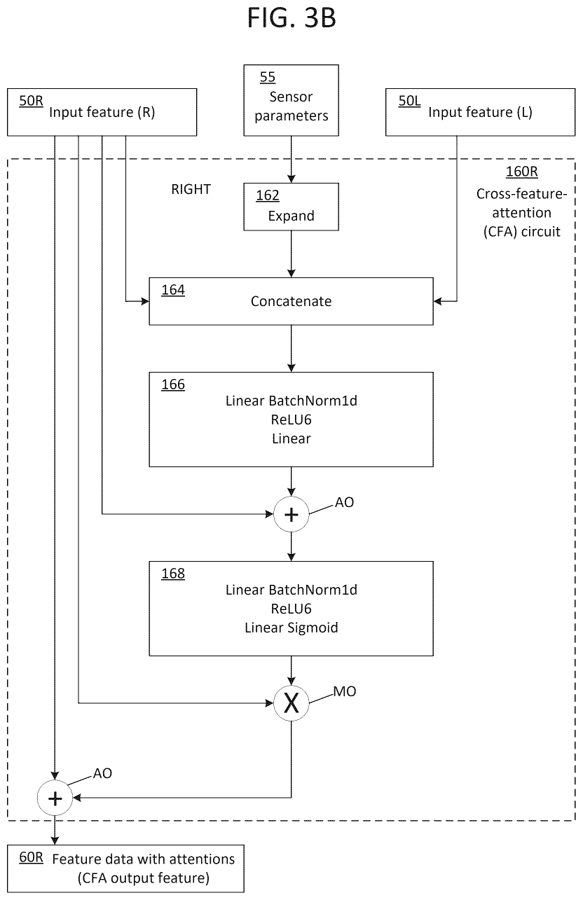

In some embodiments, a left cross-feature attention (CFA) circuit 160L may receive a CFA left-data input (e.g., corresponding to left linear-batch-normalization feature data 50L) and a CFA right-data input (e.g., corresponding to right linear-batch-normalization feature data 50R) for processing to generate left feature data with attentions 60L. In some embodiments, a right cross-feature attention (CFA) circuit 160R may receive a CFA left-data input (e.g., corresponding to left linear-batch-normalization feature data 50L) and a CFA right-data input (e.g., corresponding to right linear-batch-normalization feature data 50R) for processing to generate right feature data with attentions 60R. Operations of the CFA circuits 160 are discussed in further detail below with respect to FIGS. 3A and 3B.

In some embodiments, the CFA circuits 160 may include neural networks (e.g., CNNs, Transformers, and/or the like). In some embodiments, the CFA circuits 160 may receive sensor parameters 55 (e.g., camera parameters) as inputs for improving the accuracy of the CFA circuits 160 in generating feature data with attentions 60. The sensor parameters 55 may include (e.g., may be) parameters from the sensors 110 used to capture the image data 10. In some embodiments, the sensor parameters 55 may include intrinsic camera parameters and/or extrinsic camera parameters. For example, the intrinsic camera parameters may include translation parameters, focal length, pixel size, etc. The extrinsic camera parameters may include camera rotation parameters, camera position, and camera orientation. By using the CFA circuits 160 the system 1 may generate better (e.g., more accurate) predictions for 3D pose estimation (e.g., for the locations of the 21 joints J). For example, using the CFA circuits 160 and fused-feature data 30, the system 1 may be able to generate accurate 3D pose estimation even when some joints J may be hidden by self-occlusion (e.g., when a portion of the hand covers a portion of a joint J). Additionally, by using the backbones 120, the CFA circuits 160, and fused-feature data 30 the system 1 may perform 3D pose estimation with a smaller parameter size (PS), fewer gigabit floating-point operations (GFLOPS) (e.g., a smaller capacity or run time of the model), and with a lower per-joint error (PJ). In other words, by using the backbones 120, the CFA circuits 160, and fused-feature data 30 the system 1 may perform 3D pose estimation with improved accuracy and smaller capacity. The smaller PS and fewer GFLOPS may provide for a system 1 with smaller models that are simpler and easier to implement in mobile devices.

In some embodiments, reprojection operations 170 may be performed on the left feature data with attentions 60L and the right feature data with attentions 60R. The reprojection operations 170 may determine (e.g., may calculate) depth information from the inputs (e.g., from the left feature data with attentions 60L and the right feature data with attentions 60R) to calculate a 3D pose. For example, the inputs may include two 20×1 matrices or two 10×2 matrices, and the reprojection operations 170 may generate a 21×3 matrix indicating the locations of the 21 joints J in 3D.

FIG. 2 is a block diagram depicting operations of a fusion-feature circuit 130, according to some embodiments of the present disclosure.

Referring to FIG. 2, the feature-fusion circuit 130 (e.g., the left feature-fusion circuit 130L and the right feature-fusion circuit 130R of FIG. 1) may receive the left backbone-extracted feature data 20L and the right backbone-extracted feature data 20R as feature-fusion-circuit input data. The feature-fusion circuit 130 may perform concatenation and convolution operations on the left backbone-extracted feature data 20L and on the right backbone-extracted feature data 20R. In some embodiments, the left backbone-extracted feature data 20L may include left grid image-feature data 22L and left global image-feature data 24L. In some embodiments, the right backbone-extracted feature data 20R may include right grid image-feature data 22R and right global image-feature data 24R. Grid image-feature data 22 may have greater density than global image-feature data 24, while the global image-feature data 24 may have more global information than the grid image-feature data 22.

In some embodiments, a concatenation and/or convolution operation 132 may be performed on the left grid image-feature data 22L and the right global image-feature data 24R. In some embodiments, a concatenation and/or convolution operation 132 may be performed on the right grid image-feature data 22R and the left global image-feature data 24L. In some embodiments, a feature-fusion output concatenation operation 134 may be performed on the results of the concatenation and/or convolution operations 132 to generate the fused-feature data 30. The fused-feature data 30 may be generated to provide better performance than with left or right image features alone.

The grid image-feature data 22 and global image-feature data 24 may be extracted from the corresponding backbone 120. The features may be concatenated and processed interactively between the two images. The feature-fusion circuit 130 may help fuse the image features from the two images (e.g., from the left image data 10L and the right image data 10R) to improve the 2D-and 3D-pose estimation.

FIG. 3A is a block diagram depicting operations of the left CFA circuit 160L, according to some embodiments of the present disclosure.

Referring to FIG. 3A, the left CFA circuit 160L may receive: the left linear-batch-normalization feature data 50L (e.g., as a CFA left-data input), the right linear-batch-normalization feature data 50R (e.g., as a CFA right-data input), and the sensor parameters 55 for further processing. In some embodiments, an expand operation 162 may be performed on the sensor parameters 55. A CFA-circuit concatenation operation 164 may be performed on: the results of the expand operation 162, the left linear-batch-normalization feature data 50L, and the right linear-batch-normalization feature data 50R. A first CFA linear batch normalization operation 166 may be performed on the results of the CFA-circuit concatenation operation 164. A first add operation AO may be performed on the left linear-batch-normalization feature data 50L and the results of the first CFA linear batch normalization operation 166. A second CFA linear batch normalization operation 168 (e.g., a linear sigmoid operation) may be performed on the results of the first add operation AO. A multiplication operation MO may be performed on the left linear-batch-normalization feature data 50L and the results of the second CFA linear batch normalization operation 168. A second add operation AO may be performed on the left linear-batch-normalization feature data 50L and the results of the multiplication operation MO. The results of the second add operation AO may be provided as the left feature-data with attentions 60L.

FIG. 3B is a block diagram depicting operations of the right CFA circuit 160R, according to some embodiments of the present disclosure.

Referring to FIG. 3B, the right CFA circuit 160R may receive: the right linear-batch-normalization feature data 50R (e.g., as a CFA right-data input), the left linear-batch-normalization feature data 50L (e.g., as a CFA left-data input), and the sensor parameters 55 for further processing. In some embodiments, an expand operation 162 may be performed on the sensor parameters 55. A CFA-circuit concatenation operation 164 may be performed on: the results of the expand operation 162, the right linear-batch-normalization feature data 50R, and the left linear-batch-normalization feature data 50L. A first CFA linear batch normalization operation 166 may be performed on the results of the CFA-circuit concatenation operation 164. A first add operation AO may be performed on the right linear-batch-normalization feature data 50R and the results of the first CFA linear batch normalization operation 166. A second CFA linear batch normalization operation 168 (e.g., a linear sigmoid operation) may be performed on the results of the first add operation AO. A multiplication operation MO may be performed on the right linear-batch-normalization feature data 50R and the results of the second CFA linear batch normalization operation 168. A second add operation AO may be performed on the right linear-batch-normalization feature data 50R and the results of the multiplication operation MO. The results of the second add operation AO may be provided as the right feature-data with attentions 60R.

In summary, the attentions of the features (e.g., the hand-joint features) between the two stereo image features may be captured by the CFA circuits 160. Together with the sensor parameters 55, the two image features may be concatenated and processed by several linear layers. The attention across the two image features may be captured with linear, BatchNormld, and Sigmoid layers. Residual structure may be applied for better performance and/or generalization.

FIG. 4 is a block diagram of an electronic device in a network environment, according to some embodiments of the present disclosure.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include the processor 420 (e.g., a processing circuit or a means for processing), the memory 430, an input device 450, a sound output device 455, the display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a CPU or an application processor (AP)), and an auxiliary processor 423 (e.g., a GPU, an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as Bluetooth™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type from, the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

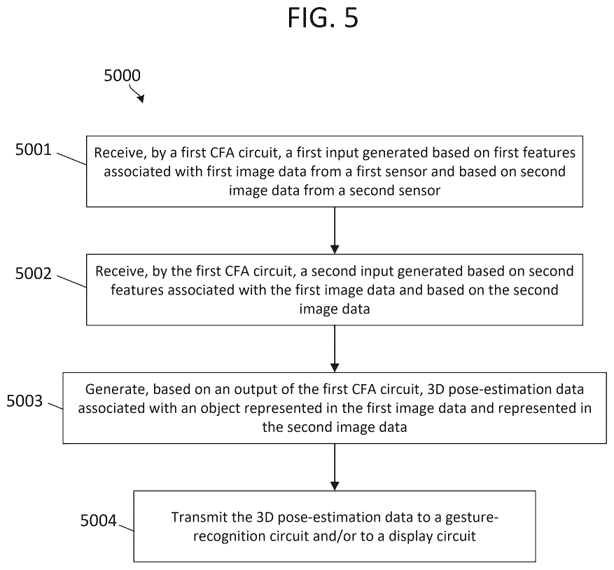

FIG. 5 is a flowchart depicting example operations of a method for 3D pose estimation, according to some embodiments of the present disclosure.

Referring to FIG. 5, a method 5000 for 3D pose estimation may include one or more of the following operations. A first CFA circuit (e.g., the left CFA circuit 160L) (e.g., a computing device) may receive a first input (e.g., the CFA left-data input) generated based on first features (e.g., the left fused-feature data 30L) associated with first image data (e.g., left image data 10L) from a first sensor (e.g., from the left sensor 110L) and based on second image data (e.g., right image data 10R) from a second sensor (e.g., the right sensor 110R) (operation 5001). In some embodiments, one or more of the operations of FIG. 5 may be performed by a single processor or by a plurality of processors. For example, some operations may be performed by a first processor and some operations may be performed by a second processor. For example, the first CFA circuit 160L may be a dedicated circuit, or a dedicated portion of a circuit, or the first CFA circuit 160L may refer to a processor performing the entire method of FIG. 5. For example, a first processor may receive the first input from a second processor or from a method or procedure executed by the first processor. The first CFA circuit (e.g., the left CFA circuit 160L) may receive a second input (e.g., the CFA right-data input) generated based on second features (e.g., the right fused-feature data 30R) associated with associated with the first image data (e.g., the left image data 10L) from the first sensor (e.g., from the left sensor 110L) and based on the second image data (e.g., the right image data 10R) from the second sensor (e.g., the right sensor 110R) (operation 5002). The system 1 may generate, based on an output (e.g., the left feature data with attentions 60L) of the first CFA circuit (e.g., the left CFA circuit 160L), 3D pose-estimation data 70 (e.g., 3D hand joints) associated with an object (e.g., a hand) represented in the first image data (e.g., the left image data 10L) and represented in the second image data (e.g., the right image data 10R) (operation 5003). For example, the output of the first processor may be delivered to a second or third processor or to a method or procedure executing in the first processor. The system 1 may transmit the 3D pose-estimation data 70 to a computing device (e.g., the second processor and/or the second device 180, including the gesture-recognition circuit 182 and/or to the display circuit 184) for further processing and/or to change a setting on the device 100 (operation 5004). For example, the object may be a hand and the gesture- recognition circuit 182 may recognize (e.g., may determine) a finger squeeze motion by analyzing the 3D pose-estimation data 70. Based on recognizing the finger squeeze motion, a computing device associated with the system 1 may cause the display circuit 184 (e.g., a display device associated with a VR headset) to zoom in on a portion of a display that displays a representation of a hand making the finger squeeze motion.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications.

Accordingly, the scope of claimed subject matter should not be limited to any of the specific exemplary teachings discussed above, but is instead defined by the following claims.

What is claimed is:

1. A method for estimating a 3-dimensional (3D) pose, the method comprising:
receiving by a computing device:
a first input generated based on first features associated with first image data from a first sensor associated with the computing device and based on second image data from a second sensor associated with the computing device; and
a second input generated based on second features associated with the first image data and based on the second image data;
based on the first input and the second input, generating, by the computing device, 3D pose-estimation data associated with an object represented in the first image data and represented in the second image data; and
transmitting the 3D pose-estimation data.

2. The method of claim 1, further comprising receiving, by the computing device, a third input comprising first sensor parameters associated with the first sensor.

3. The method of claim 1, wherein the 3D pose-estimation data is generated based on output data comprising output features with corresponding attentions, the output data being generated based on:
performing a concatenation operation on the first input and the second input; and
performing a second operation on the first input and an operand that is based on a result of the concatenation operation, the second operation being an add operation or a multiplication operation.

4. The method of claim 1, wherein:
the first features comprise first fused-feature data associated with the first image data and the second image data; and
the second features comprise second fused-feature data associated with the first image data and the second image data.

5. The method of claim 4, further comprising:
receiving, by the computing device, first image features from the first image data as a first feature-fusion input;
receiving, by the computing device, second image features from the second image data as a second feature-fusion input; and
generating the first fused-feature data based on the first feature-fusion input and the second feature-fusion input.

6. The method of claim 5, further comprising performing, by the computing device, a first concatenation operation and a first convolution operation on the first image features and on the second image features.

7. The method of claim 1, wherein:
the first sensor is positioned at a first location on an enclosure associated with the computing device;
the second sensor is positioned at a second location on the enclosure associated with the computing device; and
the second location is a different location from the first location.

8. The method of claim 1, wherein:
the first image data comprises first gray image data generated by the first sensor; and
the second image data comprises second gray image data generated by the second sensor.

9. The method of claim 1, wherein:
the object comprises a hand; and
the 3D pose-estimation data comprises 3D hand-joint data.

10. A system comprising:
one or more processors; and
a memory storing instructions which, when executed by the one or more processors, cause performance of:
receiving by the one or more processors:
a first input generated based on first features associated with first image data from a first sensor and based on second image data from a second sensor; and
a second input generated based on second features associated with the first image data and based on the second image data;
generating, based on an output of the one or more processors, 3D pose-estimation data associated with an object represented in the first image data and represented in the second image data; and
transmitting the 3D pose-estimation data.

11. The system of claim 10, wherein the instructions, when executed by the one or more processors, cause performance of receiving, by the one or more processors, a third input comprising first sensor parameters associated with the first sensor.

12. The system of claim 10, wherein the output of the one or more processors comprises output features with corresponding attentions generated based on:
performing a concatenation operation on the first input and the second input; and
performing a second operation on the first input and an operand that is based on a result of the concatenation operation, the second operation being an add operation or a multiplication operation.

13. The system of claim 10, wherein:
the first features comprise first fused-feature data associated with the first image data and the second image data; and
the second features comprise second fused-feature data associated with the first image data and the second image data.

14. The system of claim 13, wherein the instructions, when executed by the one or more processors, cause performance of:
receiving, by the one or more processors, first image features from the first image data as a first feature-fusion input;
receiving, by the one or more processors, second image features from the second image data as a second feature-fusion input; and
generating the first fused-feature data based on the first feature-fusion input and the second feature-fusion input.

15. The system of claim 14, wherein the instructions, when executed by the one or more processors, cause performance of a first concatenation operation and a first convolution operation on the first image features and on the second image features.

16. The system of claim 10, wherein:
the first sensor is positioned at a first location on the system;
the second sensor is positioned at a second location on the system; and
the second location is a different location from the first location.

17. The system of claim 10, wherein:
the first image data comprises first gray image data generated by the first sensor; and
the second image data comprises second gray image data generated by the second sensor.

18. The system of claim 10, wherein:
the object comprises a hand; and
the 3D pose-estimation data comprises 3D hand-joint data.

19. A system comprising:
means for processing; and
a memory storing instructions which, when executed by the means for processing, cause performance of:
receiving, by the means for processing:
a first input generated based on first features associated with first image data from a first sensor and based on second image data from a second sensor; and
a second input generated based on second features associated with the first image data and based on the second image data;
generating, based on an output of the means for processing, 3D pose-estimation data associated with an object in the first image data and in the second image data; and
transmitting the 3D pose-estimation data.

20. The system of claim 19, wherein the instructions, when executed by the means for processing, cause performance of receiving, by the means for processing, a third input comprising first sensor parameters associated with the first sensor.
